(19) United States
(12) Patent Application Publication
(10) Pub. No.: US 2025/0360763 A1
(43) Pub. Date: Nov. 27, 2025

(54) Hitch Adapter Assembly

(71) Applicant: Pat Dowden, Loomis, CA (US)

(72) Inventor: Pat Dowden, Loomis, CA (US)

(21) Appl. No.: 18/672,459

(22) Filed: May 23, 2024

(51) Int. Cl. B60D 1/52; B60D 1/24

(52) U.S. Cl. CPC B60D 1/52; B60D 1/24

(57) ABSTRACT

A hitch adapter assembly includes an adjustable insert assembly and a hitch receiving assembly designed to receive a male hitch insert and that is mounted on the adjustable insert assembly. The adjustable insert assembly is insertable into a hitch receiver of a vehicle and includes a first tubular portion, a second tubular portion, and a connecting bar assembly positioned within and connecting the first tubular portion to the second tubular portion. The connecting bar assembly is adjustable to relatively move the first tubular portion and the second tubular portion from an aligned position to an offset position to expand the overall diameter of the adjustable insert assembly and exert a pressing force against opposing interior surfaces of a hitch receiver of a vehicle to tightly secure the adjustable insert assembly therein and minimize or prevent vibration during transport.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tow hitch devices and accessories and more particularly pertains to a new hitch adapter assembly that is adjustable for adapting a standard two-inch male hitch insert to any size female hitch receiver of a vehicle with a tight fit to minimize or prevent vibration and oscillation of an attached device, such as a bike rack, luggage rack, or trailer. Female hitch receivers on vehicles come in different sizes, such as two inches, two and a half inches, and three inches, whereas most male hitch inserts are only two inches. Current hitch receiver adapters or reducers do not prevent undesirable vibration and oscillation of a device attached thereto during operation of the vehicle, especially at higher speeds.

### (2) Description of Related Art including information disclosed under 37 CFR 1.97 and 1.98

The prior art relates to tow hitch devices and accessories. The prior art, as best understood, does not disclose a hitch adapter assembly that has an adjustable portion for adapting a standard male hitch insert to any size female hitch receiver of a vehicle with a tight fit to minimize vibration and oscillation of an attached device, such as a bike rack, luggage rack, or trailer, and a fixed portion attached to the adjustable portion that has a hitch receiver to receive and securely hold a standard male hitch insert.

### (h) BRIEF SUMMARY OF THE INVENTION

An embodiment of the disclosure meets the needs presented above in a hitch adapter assembly generally comprising an adjustable insert assembly and a hitch receiving assembly designed to receive a male hitch insert and that is mounted on the adjustable insert assembly. The adjustable insert assembly is insertable into a hitch receiver of a vehicle and includes a first tubular portion, a second tubular portion, and a connecting bar assembly positioned within and connecting the first tubular portion to the second tubular portion. The connecting bar assembly is adjustable to relatively move the first tubular portion and the second tubular portion from an aligned position to an offset position to expand the overall diameter of the adjustable insert assembly and exert a pressing force against opposing interior surfaces of a hitch receiver of a vehicle to tightly secure the adjustable insert assembly therein and minimize or prevent vibration during transport.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hitch adapter assembly according to an embodiment of the disclosure.

FIG. 2 is an exploded view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a bottom view of an embodiment of the disclosure.

FIG. 7 is a cross-sectional view of an embodiment of the disclosure.

FIG. 8 is a cross-sectional view of an embodiment of the disclosure in use.

FIG. 9 is a perspective view of a component of an alternative embodiment of the disclosure.

### (j) DETAILED DESCRIPTION OF THE INVENTION

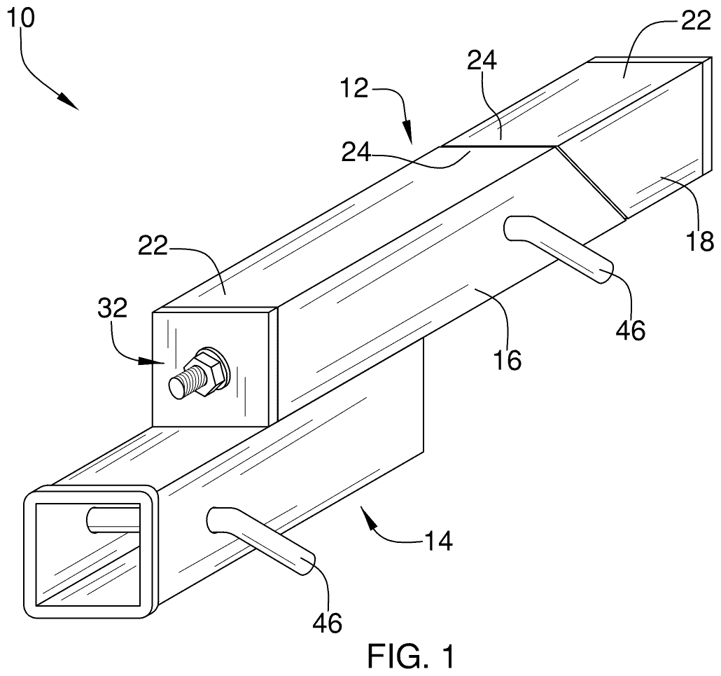

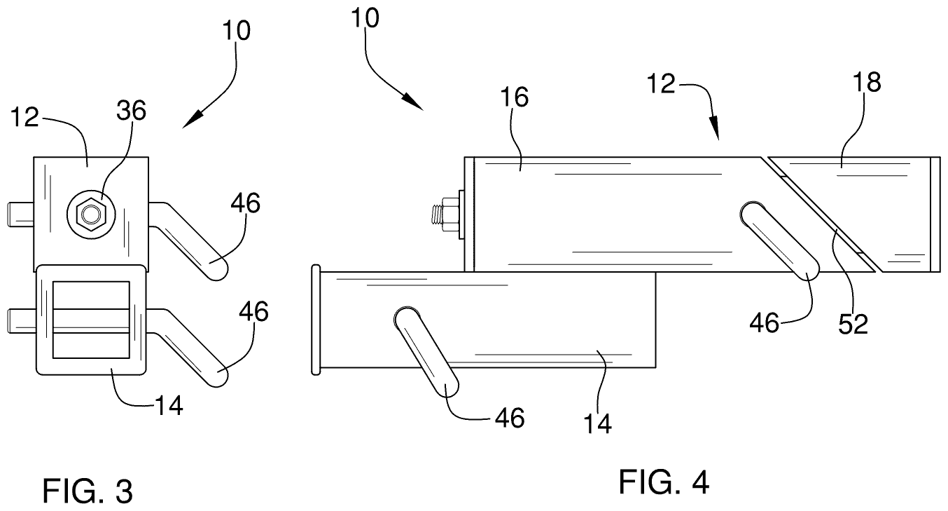

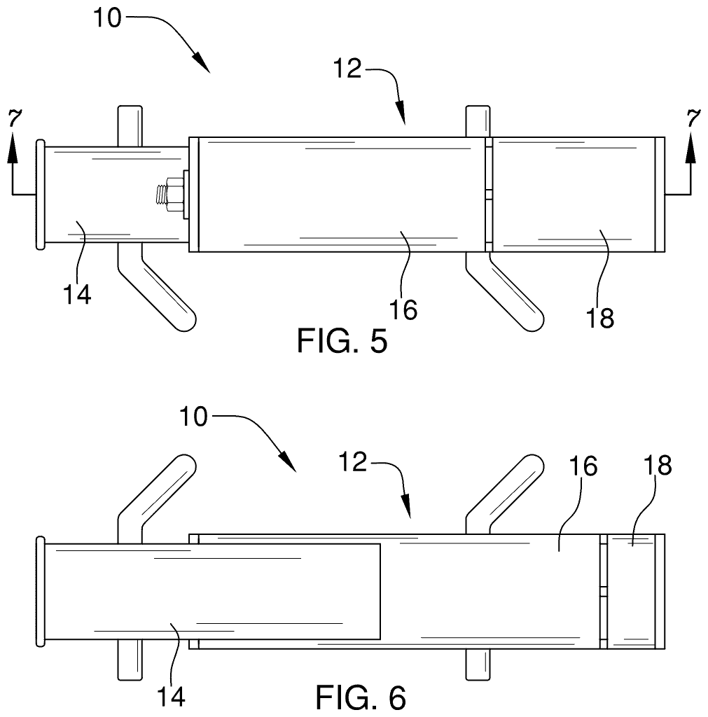

With reference now to the drawings, and in particular to FIGS. 1 through 9 thereof, a new hitch adapter assembly embodying the principles and concepts of an embodiment of the disclosure and generally designated by the reference numeral 10 will be described.

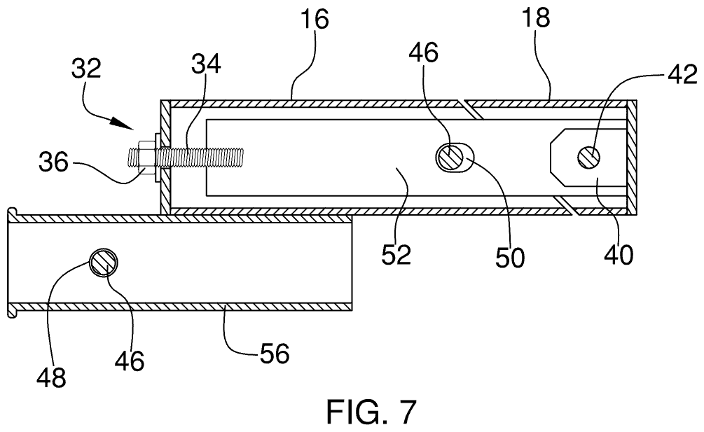

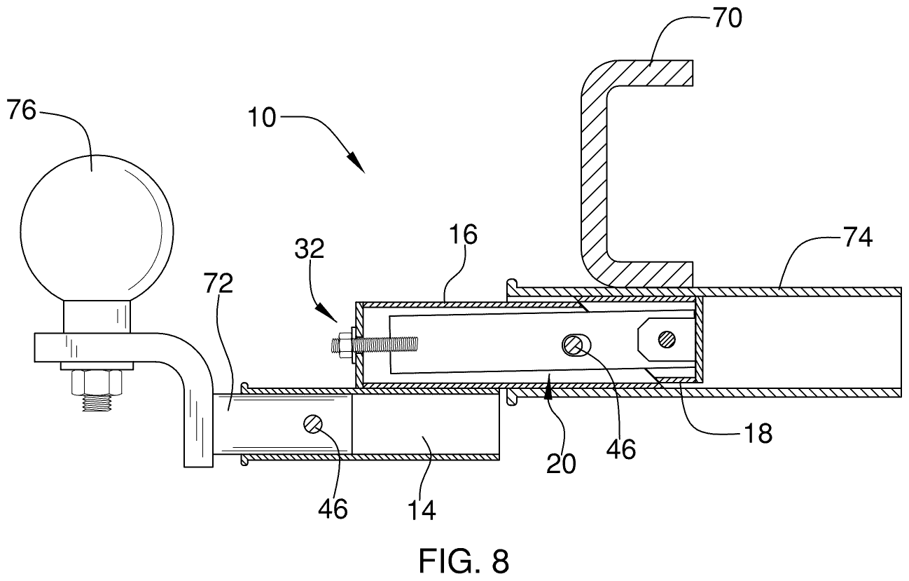

As best illustrated in FIGS. 1 through 9, the hitch adapter assembly 10 generally comprises an adjustable insert assembly 12 and a hitch receiving assembly 14 designed to receive a male hitch insert 72 and that is mounted on the adjustable insert assembly 12. The adjustable insert assembly 12 is insertable into a hitch receiver 74 of a vehicle 70 and includes a first tubular portion 16, a second tubular portion 18, and a connecting bar assembly 20 positioned within and connecting the first tubular portion 16 to the second tubular portion 18. The connecting bar assembly 20 is adjustable to relatively move the first tubular portion 16 and the second tubular portion 18 from an aligned position, as shown in FIG. 7, to an offset position, as shown in FIG. 8, to expand the overall diameter of the adjustable insert assembly 12 and exert a pressing force against opposing interior surfaces of a hitch receiver 74 of a vehicle 70 to tightly secure the adjustable insert assembly 12 therein and minimize or prevent vibration during transport.

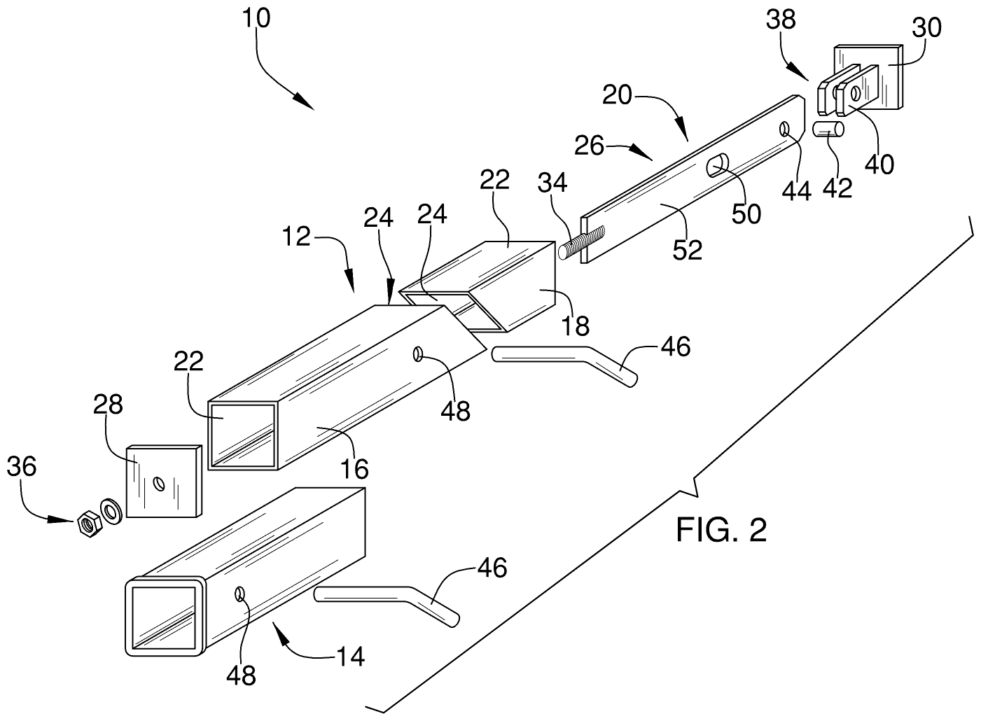

Each of the first and second tubular portions 16, 18 has a square profile to fit into a square hitch receiver 74 of a vehicle 70. As seen in FIGS. 1 and 2, each of the first and second tubular portions 16, 18 includes a closed end portion 22 and an open end portion 24, wherein the open end portions 24 are beveled and positioned to face one another with their surrounding edges in a complementary engagement. This beveled design, or possibly a chamfered design in one possible embodiment, permits the sliding or translational movement between the first and second tubular portions 16, 18, as shown in FIG. 8.

As seen in FIGS. 2 and 7, the connecting bar assembly 20 includes a brace structure 26 connected to a first end plate 28 of the closed end portion 22 of the first tubular portion 16 and a second end plate 30 of the closed end portion 22 of the second tubular portion 18. The connecting bar assembly 20 includes an adjustment assembly 32 that includes a rod 34 and a securing structure 36, wherein the rod 34 is attached to a first end of the brace structure 26 and positioned to project out through an orifice in the first end plate 28 and be secured to the outer surface of the first end plate 28. The securing structure 36 is adjustable to axially move the rod 34 and the brace structure 26 and thereby cause relative sliding movement of the first and second tubular portions 16, 18 at the open end portions 24. In the exemplary embodiment shown, the rod 34 is threaded and the securing structure 36 includes a threaded nut that is manually adjustable, though any other adjustable securing structure 36 would be suitable. The connecting bar assembly 20 includes a pivot assembly 38 that includes a support bracket 40 attached to the second end plate 30 and a pivot pin 42 held by the support bracket 40 and inserted through a pivot orifice 44 in a second end of the brace structure 26 to permit pivoting and relative sliding movement of the first and second tubular portions 16, 18.

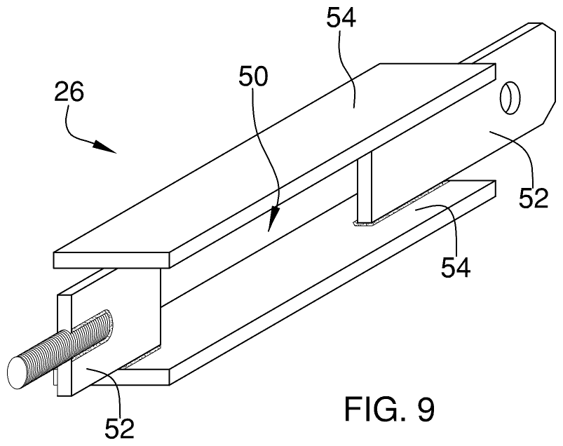

The adjustable insert assembly 12 includes a hitch pin 46 and a pair of pin orifices 48 positioned in the first tubular portion 16, wherein the pair of pin orifices 48 are to be aligned with matching hitch receiver 74 orifices to permit the hitch pin 46 to be inserted through the pair of pin orifices 48 and hitch receiver 74 orifices to secure the adjustable insert assembly 12 to a hitch receiver 74, as shown in FIG. 8. The brace structure 26 includes an expanded opening 50 therein to permit passage of the hitch pin 46 and movement of the brace structure 26 during relative sliding movement of the first and second tubular portions 16, 18. The brace structure 26 also includes a flat bar 52 positioned vertically and perpendicular to the hitch pin 46 when the adjustable insert assembly 12 is installed in a hitch receiver 74. As shown in FIGS. 2 and 8, the expanded opening 50 is in the form of an oblong orifice in the flat bar 52. In another possible embodiment shown in FIG. 9, the expanded opening 50 divides the flat bar 52 into two sections connected by at least one connecting piece 54, such as two connecting pieces 54 shown in FIG. 9, attached to the edges of the two sections.

The hitch receiving assembly 14 includes a tubular receiver 56 designed to receive a male hitch insert 72. The tubular receiver 56 is attached to an underside of the first tubular portion 16 when the adjustable insert assembly 12 is installed in a hitch receiver 74, as shown in FIG. 8. The hitch receiving assembly 14 also includes a hitch pin 46 and a pair of pin orifices 48 positioned in the tubular receiver 56, wherein the pair of pin orifices 48 are to be aligned with matching male hitch insert 72 orifices to permit the hitch pin 46 to be inserted through the pair of pin orifices 48 and male hitch insert 72 orifices to secure a male hitch insert 72 to the tubular receiver 56, as shown in FIG. 8. In at least one embodiment, the tubular receiver 56 has a square profile. The tubular receiver 56 can have an inner diameter that matches a standard two-inch male hitch insert 72.

The hitch adapter assembly 10 is used to adapt a standard male hitch insert 72 to fit securely into a female hitch receiver 74 on a vehicle 70 regardless of the size of the female hitch receiver 74. Most devices, such as bike racks, luggage racks, and trailers, utilize a male hitch insert 72 that has a standard two-inch by two-inch size. However, female hitch receivers 74 on vehicles 70 vary in size, most commonly in two-inch, two-and-a-half-inch, and three-inch designs. Obviously, a two-inch male hitch insert 72 will not fit securely in a larger female hitch receiver 74. In addition, even in the case of two-inch female hitch receivers, 74 the fit may not be very secure. The hitch adapter assembly 10 promotes or guarantees a very secure connection. The user inserts the second tubular portion 18 and at least a portion of the first tubular portion 16 into a hitch receiver 74 of a vehicle 70. The hitch receiver 74 has an inner diameter greater than an outer diameter of the standard male hitch insert 72 of a device to be mounted on a vehicle 70 via the hitch receiver 74. The user then adjusts the connecting bar assembly 20 and relatively moves the first tubular portion 16 and the second tubular portion 18 from an aligned position to an offset position, as shown in FIG. 8. The user thereby expands the overall diameter of the adjustable insert assembly 12 and exerts a pressing force against opposing interior surfaces of the hitch receiver 74, which thereby tightly secures the adjustable insert assembly 12 therein and minimizes or prevents vibration during transport. The standard male insert of the device is then inserted into the hitch receiving assembly 14 mounted on the adjustable insert assembly 12. The user then further secures each of the standard male insert and the adjustable insert assembly 12 in place with hitch pins 46. As a result, the standard male insert and the adjustable insert assembly 12 are secured against removal by the hitch pins 46 and by the friction force. This very secure connection minimizes or prevents vibration and oscillation of the devices mounted on the vehicle 70 by the hitch adapter assembly 10. FIG. 8 shows a trailer hitch 76 attached to the male hitch insert 72, though this is for exemplary purposes only.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hitch adapter assembly comprising:
an adjustable insert assembly insertable into a hitch receiver of a vehicle and comprising a first tubular portion, a second tubular portion, and a connecting bar assembly disposed within and connecting said first tubular portion to said second tubular portion, wherein said connecting bar assembly is adjustable to relatively move said first tubular portion and said second tubular portion from an aligned position to an offset position to expand the overall diameter of the adjustable insert assembly and exert a pressing force against opposing interior surfaces of a hitch receiver of a vehicle to tightly secure the adjustable insert assembly therein and minimize or prevent vibration during transport; and
a hitch receiving assembly configured to receive a male hitch insert and being mounted on said adjustable insert assembly.

2. The hitch adapter assembly of claim 1, wherein each of said first and second tubular portions has a square profile to fit into a square hitch receiver of a vehicle.

3. The hitch adapter assembly of claim 1, wherein each of said first and second tubular portions comprises a closed end portion and an open end portion, wherein said open end portions are beveled and disposed to face one another with their surrounding edges in a complementary engagement.

4. The hitch adapter assembly of claim 1, wherein said connecting bar assembly comprises a brace structure connected to a first end plate of said closed end portion of said first tubular portion and a second end plate of said closed end portion of said second tubular portion.

5. The hitch adapter assembly of claim 4, wherein said connecting bar assembly comprises an adjustment assembly that comprises a rod and a securing structure, wherein said rod is attached to a first end of said brace structure and disposed to project out through an orifice in said first end plate and be secured to the outer surface of said first end plate, and wherein said securing structure is adjustable to axially move said rod and said brace structure and thereby cause relative sliding movement of said first and second tubular portions at said open end portions.

6. The hitch adapter assembly of claim 5, wherein said rod is threaded and said securing structure comprises a threaded nut that is manually adjustable.

7. The hitch adapter assembly of claim 4, wherein said connecting bar assembly comprises a pivot assembly that comprises a support bracket attached to said second end plate and a pivot pin held by said support bracket and inserted through a pivot orifice in a second end of said brace structure to permit pivoting and relative sliding movement of said first and second tubular portions.

8. The hitch adapter assembly of claim 1, wherein the adjustable insert assembly comprises a hitch pin and a pair of pin orifices disposed in said first tubular portion, wherein said pair of pin orifices are to be aligned with matching hitch receiver orifices to permit said hitch pin to be inserted through said pair of pin orifices and hitch receiver orifices to secure the adjustable insert assembly to a hitch receiver.

9. The hitch adapter assembly of claim 4, wherein the adjustable insert assembly comprises a hitch pin and a pair of pin orifices disposed in said first tubular portion, wherein said pair of pin orifices are to be aligned with matching hitch receiver orifices to permit said hitch pin to be inserted through said pair of pin orifices and hitch receiver orifices to secure the adjustable insert assembly to a hitch receiver.

10. The hitch adapter assembly of claim 9, wherein said brace structure comprises an expanded opening therein to permit passage of said hitch pin and movement of said brace structure during relative sliding movement of said first and second tubular portions.

11. The hitch adapter assembly of claim 10, wherein said brace structure comprises a flat bar disposed vertically and perpendicular to said hitch pin when the adjustable insert assembly is installed in a hitch receiver.

12. The hitch adapter assembly of claim 11, wherein said expanded opening comprises an oblong orifice in said flat bar.

13. The hitch adapter assembly of claim 11, wherein said expanded opening divides said flat bar into two sections connected by at least one connecting piece attached to the edges of said two sections.

14. The hitch adapter assembly of claim 1, wherein said hitch receiving assembly comprises a tubular receiver configured to receive a male hitch insert.

15. The hitch adapter assembly of claim 14, wherein said tubular receiver is attached to an underside of said first tubular portion when the adjustable insert assembly is installed in a hitch receiver.

16. The hitch adapter assembly of claim 14, wherein said hitch receiving assembly comprises a hitch pin and a pair of pin orifices disposed in said tubular receiver, wherein said pair of pin orifices are to be aligned with matching hitch insert orifices to permit said hitch pin to be inserted through said pair of pin orifices and hitch insert orifices to secure a male hitch insert to said tubular receiver.

17. The hitch adapter assembly of claim 14, wherein said tubular receiver has a square profile.

18. The hitch adapter assembly of claim 14, wherein said tubular receiver has an inner diameter that matches a standard two-inch male hitch insert.

19. A method of using the hitch adapter assembly of claim 1, comprising the steps of:
inserting said second tubular portion and at least a portion of said first tubular portion into a hitch receiver of a vehicle, wherein said hitch receiver has an inner diameter greater than an outer diameter of a standard male hitch insert of a device to be mounted on a vehicle via said hitch receiver;
adjusting said connecting bar assembly and relatively moving said first tubular portion and said second tubular portion from an aligned position to an offset position and thereby expanding the overall diameter of the adjustable insert assembly and exerting a pressing force against opposing interior surfaces of said hitch receiver and thereby tightly securing the adjustable insert assembly therein and minimizing or preventing vibration during transport;
inserting said standard male insert of the device into said hitch receiving assembly mounted on said adjustable insert assembly; and
further securing each of said standard male insert and the adjustable insert assembly in place with hitch pins.

20. A hitch adapter assembly comprising:
an adjustable insert assembly insertable into a hitch receiver of a vehicle and comprising a first tubular portion, a second tubular portion, and a connecting bar assembly disposed within and connecting said first tubular portion to said second tubular portion, wherein said connecting bar assembly is adjustable to relatively move said first tubular portion and said second tubular portion from an aligned position to an offset position to expand the overall diameter of the adjustable insert assembly and exert a pressing force against opposing interior surfaces of a hitch receiver of a vehicle to tightly secure the adjustable insert assembly therein and minimize or prevent vibration during transport, wherein:
each of said first and second tubular portions has a square profile to fit into a square hitch receiver of a vehicle,
each of said first and second tubular portions comprises a closed end portion and an open end portion, wherein said open end portions are beveled and disposed to face one another with their surrounding edges in a complementary engagement,
said connecting bar assembly comprises a brace structure connected to a first end plate of said closed end portion of said first tubular portion and a second end plate of said closed end portion of said second tubular portion,
said connecting bar assembly comprises an adjustment assembly that comprises a rod and a securing structure, wherein said rod is attached to a first end of said brace structure and disposed to project out through an orifice in said first end plate and be secured to the outer surface of said first end plate, and wherein said securing structure is adjustable to axially move said rod and said brace structure and thereby cause relative sliding movement of said first and second tubular portions at said open end portions, wherein:
said rod is threaded and said securing structure comprises a threaded nut that is manually adjustable,
said connecting bar assembly comprises a pivot assembly that comprises a support bracket attached to said second end plate and a pivot pin held by said support bracket and inserted through a pivot orifice in a second end of said brace structure to permit pivoting and relative sliding movement of said first and second tubular portions,
the adjustable insert assembly comprises a hitch pin and a pair of pin orifices disposed in said first tubular portion, wherein said pair of pin orifices are to be aligned with matching hitch receiver orifices to permit said hitch pin to be inserted through said pair of pin orifices and hitch receiver orifices to secure the adjustable insert assembly to a hitch receiver, wherein:
said brace structure comprises an expanded opening therein to permit passage of said hitch pin and movement of said brace structure during relative sliding movement of said first and second tubular portions,
said brace structure comprises a flat bar disposed vertically and perpendicular to said hitch pin when the adjustable insert assembly is installed in a hitch receiver, wherein one of (A) and (B):
(A) said expanded opening comprises an oblong orifice in said flat bar,
(B) said expanded opening divides said flat bar into two sections connected by at least one connecting piece attached to the edges of said two sections; and
a hitch receiving assembly configured to receive a male hitch insert and being mounted on said adjustable insert assembly, wherein:
said hitch receiving assembly comprises a tubular receiver configured to receive a male hitch insert,
said tubular receiver is attached to an underside of said first tubular portion when the adjustable insert assembly is installed in a hitch receiver,
said hitch receiving assembly comprises a hitch pin and a pair of pin orifices disposed in said tubular receiver, wherein said pair of pin orifices are to be aligned with matching hitch insert orifices to permit said hitch pin to be inserted through said pair of pin orifices and hitch insert orifices to secure a male hitch insert to said tubular receiver,
said tubular receiver has a square profile, and
said tubular receiver has an inner diameter that matches a standard two-inch male hitch insert.
